(19) United States
(12) Patent Application Publication
(10) Pub. No.: US 2025/0328738 A1
(43) Pub. Date: Oct. 23, 2025

(54) RESPONSE INFORMATION GENERATION METHOD, DATABASE ESTABLISHMENT METHOD AND ELECTRONIC DEVICE

(71) Applicant: Lenovo (Beijing) Limited, Beijing (CN)

(72) Inventors: Jun PAN, Beijing (CN); Xinbin LIU, Beijing (CN)

(21) Appl. No.: 19/178,503

(22) Filed: Apr. 14, 2025

(30) Foreign Application Priority Data
Apr. 17, 2024 (CN) 202410466125.7

(51) Int. Cl. G06F 40/40; G06F 16/334; G06F 40/117

(52) U.S. Cl. CPC G06F 40/40; G06F 16/3347; G06F 40/117

(57) ABSTRACT

A response information generation method includes obtaining first query information of a user, retrieving a first sub-text block matching the first query information, and determining a target parent text block corresponding to the first sub-text block. The target parent text block includes the first sub-text block and a second sub-text block associated with the first sub-text block. The method also includes determining first response information corresponding to the first query information based on the target parent text block using a target model.

### CROSS-REFERENCES TO RELATED APPLICATIONS

The present disclosure claims priority of Chinese Patent Application No. 202410466125.7, filed on Apr. 17, 2024, the entire content of which is hereby incorporated by reference.

### FIELD OF THE DISCLOSURE

The present disclosure generally relates to the field of large model technology and, more particularly, relates to a response information generation method, a database establishment method, and a device.

### BACKGROUND

With the advent of Chat-GPT, various large-model products have been launched one after another. It is worth noting that the quality of a large model in answering questions depends not only on the ability of the model itself, but also on providing the model with appropriate prompts based on user documents.

However, directly inputting unprocessed documents into a large model may result in texts being too long, affecting the performance and effect of the large model. When the length of a document to be processed is longer than the acceptable length of the model, a conventional approach is to split the document into a plurality of text blocks, and only keep the text blocks containing information needed to solve the problem and input the text blocks containing the information needed to solve the problem to the large model. During this process, the technology for retrieving useful information may include the retrieval augmented generation (RAG) technology. When retrieving useful information, a vector database may be established for text blocks, and a vector search method may be used to find the text blocks that are most likely to contain useful information. When the segmented text blocks are too small, the segmented text blocks may not contain entire useful information, resulting in errors and deviations in answers by the large model. However, when the segmented text blocks are too large, document retrieval may consume more time and resources, and difficulty of target hitting may increase. In addition, when recalling with a conventional method, improper positions of segmented text blocks may destroy the semantics between segments, resulting in incomplete semantics within the text blocks.

### SUMMARY

One aspect of the present disclosure includes a response information generation method. The method includes obtaining first query information of a user, retrieving a first sub-text block matching the first query information, and determining a target parent text block corresponding to the first sub-text block. The target parent text block includes the first sub-text block and a second sub-text block associated with the first sub-text block. The method also includes determining first response information corresponding to the first query information based on the target parent text block using a target model.

Another aspect of the present disclosure includes a database establishment method. The method includes segmenting a user document of into a plurality of sub-text blocks, storing the plurality of sub-text blocks in a vector database, splicing mutually related sub-text blocks of the plurality of sub-text blocks to obtain a plurality of parent text blocks, and storing the plurality of parent text blocks in a relational database.

Another aspect of the present disclosure includes an electronic device. The electronic device includes one or more processors, and a memory containing a computer program that, when being executed, causes the one or more processors to perform: obtaining first query information of a user; retrieving a first sub-text block matching the first query information; determining a target parent text block corresponding to the first sub-text block, the target parent text block including the first sub-text block and a second sub-text block associated with the first sub-text block; and determining first response information corresponding to the first query information based on the target parent text block using a target model.

Another aspect of the present disclosure includes an electronic device. The electronic device includes one or more processors, and a memory containing a computer program that, when being executed, causes the one or more processors to perform segmenting a user document of into a plurality of sub-text blocks; storing the plurality of sub-text blocks in a vector database; splicing mutually related sub-text blocks of the plurality of sub-text blocks to obtain a plurality of parent text blocks; and storing the plurality of parent text blocks in a relational database.

Other aspects of the present disclosure may be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIG. 1 illustrates a flow chart of a response information generation method consistent with the disclosed embodiments of the present disclosure;

FIG. 2 illustrates a flow chart of another response information generation method consistent with the disclosed embodiments of the present disclosure;

FIG. 3 illustrates a flow chart of a database establishment method consistent with the disclosed embodiments of the present disclosure;

FIG. 4 illustrates a schematic structural diagram of a database establishment method consistent with the disclosed embodiments of the present disclosure;

FIG. 5 illustrates a flow chart of another database establishment method consistent with the disclosed embodiments of the present disclosure;

FIG. 6 illustrates a schematic diagram of splicing text blocks into a parent text block, consistent with the disclosed embodiments of the present disclosure;

FIG. 7 illustrates a flow chart of another database establishment method consistent with the disclosed embodiments of the present disclosure;

FIG. 8 illustrates a flow chart of another database establishment method consistent with the disclosed embodiments of the present disclosure;

FIG. 9 illustrates a flow chart of another database establishment method consistent with the disclosed embodiments of the present disclosure;

FIG. 10 illustrates a flow chart of another database establishment method consistent with the disclosed embodiments of the present disclosure;

FIG. 11 illustrates a flow chart of another database establishment method consistent with the disclosed embodiments of the present disclosure;

FIG. 12 illustrates a flow chart of another database establishment method consistent with the disclosed embodiments of the present disclosure;

FIG. 13 illustrates a schematic composition structural diagram of a response information generation device consistent with the disclosed embodiments of the present disclosure;

FIG. 14 illustrates a schematic composition structural diagram of a database establishment device consistent with the disclosed embodiments of the present disclosure; and

FIG. 15 illustrates a schematic structural diagram of an electronic device consistent with the disclosed embodiments of the present disclosure.

### DETAILED DESCRIPTION

To make the objectives, technical solutions and advantages of the present disclosure more clear and explicit, the present disclosure is described in further detail with accompanying drawings and embodiments. It should be understood that the specific exemplary embodiments described herein are only for explaining the present disclosure and are not intended to limit the present disclosure.

It should be noted that in the present disclosure, relational terms such as “first” and “second” are only configured to distinguish one entity or operation from another entity or operation, and do not necessarily require or imply that such actual relationship or sequence exists between these entities or operations. Terms “comprise”, “include” or any other variations thereof are intended to cover a non-exclusive inclusion. A process, method, article, or apparatus that includes a series of elements includes not only the series of elements, but also other elements not expressly listed, or elements inherent to such a process, method, article, or apparatus. Without further limitation, an element defined by a statement like “comprises a . . . ” does not exclude the presence of additional identical elements in a process, method, article, or apparatus that includes the foregoing element.

It should be noted that relative arrangements of components and operations, numerical expressions and numerical values set forth in exemplary embodiments are for illustration purposes only and are not intended to limit the present disclosure unless otherwise specified. Techniques, methods and apparatus known to the skilled in the relevant art may not be discussed in detail, but these techniques, methods and apparatus should be considered as a part of the specification, where appropriate.

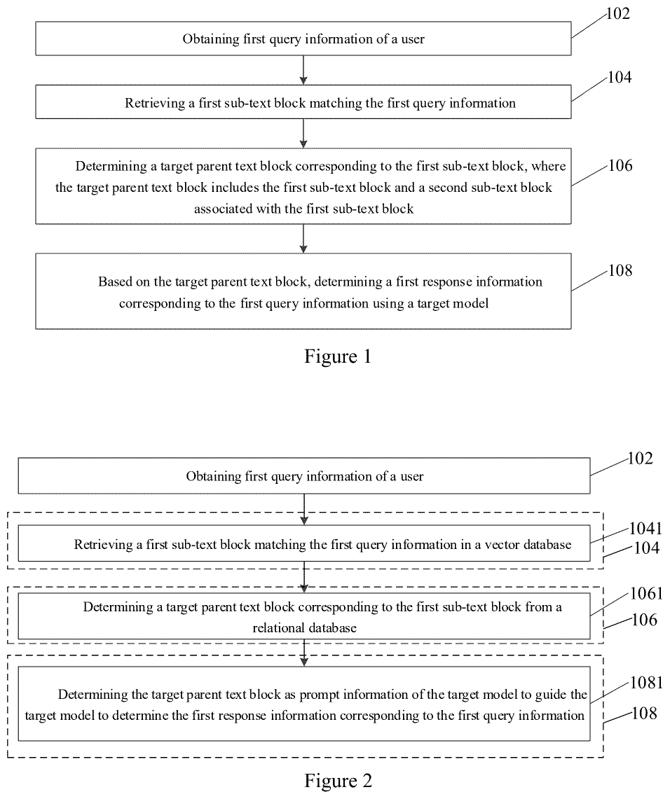

The present disclosure provides a response information generation method. FIG. 1 illustrates a flow chart of a response information generation method consistent with the disclosed embodiments of the present disclosure. Referring to FIG. 1, the response information generation method includes S102, S104, S106 and S108.
S102: obtaining first query information of a user. The first query information may be a query statement input by the user, that is, a question asked by the user.
S104: retrieving a first sub-text block matching the first query information. The first sub-text block may be a text block containing information required to solve the question, retrieved from a user document using a vector retrieval method. The text length of the first sub-text block may be relatively short.
S106: determining a target parent text block corresponding to the first sub-text block. The target parent text block may include the first sub-text block and a second sub-text block associated with the first sub-text block.

The target parent text block is formed by splicing the first sub-text block and the second sub-text block which are associated with each other, and the text length of the target parent text block may be relatively long. When a sub-text block is short (too small), the sub-text block may not contain the entire useful information, causing errors and deviations when the large model answer questions. When a sub-text block is long (too large), document retrieval may consume more time and resources. As such, a small first sub-text block may be retrieved first, and then a large parent text block corresponding to the sub-text block may be determined. The semantic information contained in the parent text block may be more complete.

S108: based on the target parent text block, determining a first response information corresponding to the first query information using a target model. The target model may be a large model, also called a large-scale model. A large model may also be called a foundation model, and refers to a machine learning model with large-scale parameters and complex computing structures. A large model is typically built from deep neural networks and may have billions or even hundreds of billions of parameters. Purposes of designing a large model include to improve the expressiveness and predictive performance of a model and to be able to handle complex tasks and data. Large models are widely used in various fields, including natural language processing, computer vision, speech recognition, and recommendation systems. Large models may learn complex patterns and features by training with massive amounts of data. Large models may have strong generalization capabilities and may make accurate predictions on unseen data. The large models may be GPT, Chat-GPT, Falcon, etc.

The first response information may be an answer output by the target model according to the question asked by a user. When the user inputs the first query information, the first sub-text block matching the first query information may be retrieved first. Then, a target parent text block containing more information may be determined based on the first sub-text block. The target parent text block and the first query information may be input into the target model. The target model may generate a final answer (i.e., the first response information) based on the target parent text block and the first query information.

In one embodiment, the first sub-text block that matches the first query information may be determined first, and the target parent text block corresponding to the first sub-text block may then be determined. Based on the target parent text block, a target model may be used to determine the first response information corresponding to the first query information. By using two types of text blocks, sub-text block and parent text block, for vector database retrieval and large model answer generation respectively, needs for retrieval performance and large-model generation performance may be met simultaneously. Accordingly, the semantic information contained in each text block may be more complete, the answer generation of the large model may be more accurate, and the retrieval efficiency may be higher. In addition, problems, such as, loss of useful information due to small sizes of the segmented text blocks, which leads to errors and deviations in answers of the large model, or more time and resource consumption by document retrieval and increased difficulty of target hitting due to large sizes of the segmented text blocks, may be avoided.

FIG. 2 illustrates a flow chart of another response information generation method consistent with the disclosed embodiments of the present disclosure. In some embodiments, an operation of S104 “retrieving a first sub-text block matching the first query information” includes S1041: retrieving a first sub-text block matching the first query information in a vector database. A plurality of sub-text blocks may be pre-stored in the vector database. The first sub-text block matching the first query information may be retrieved from the vector database.

An operation of S106 “determining a target parent text block corresponding to the first sub-text block” includes S1061: determining a target parent text block corresponding to the first sub-text block from a relational database. The relational database may store a plurality of parent text blocks, and each parent text block corresponds to one or more sub-text block in the vector database. As such, the target parent text block corresponding to the first sub-text block may be determined from the relational database. The target parent text block may include a first sub-text block and a second sub-text block associated with the first sub-text block. The target parent text block may be formed by splicing the first sub-text block and one or more one second sub-text block.

An operation of S108 “based on the target parent text block, determining a first response information corresponding to the first query information using a target model” includes S1081: determining the target parent text block as prompt information of the target model to guide the target model to determine the first response information corresponding to the first query information.

The first sub-text block that matches the first query information may be retrieved from the vector database first, and then the target parent text block with more information may be derived from the relational database based on the first sub-text block. The target parent text block and the first query information may be input into the target model, and the target model may generate the final answer according to the target parent text block and the first query information.

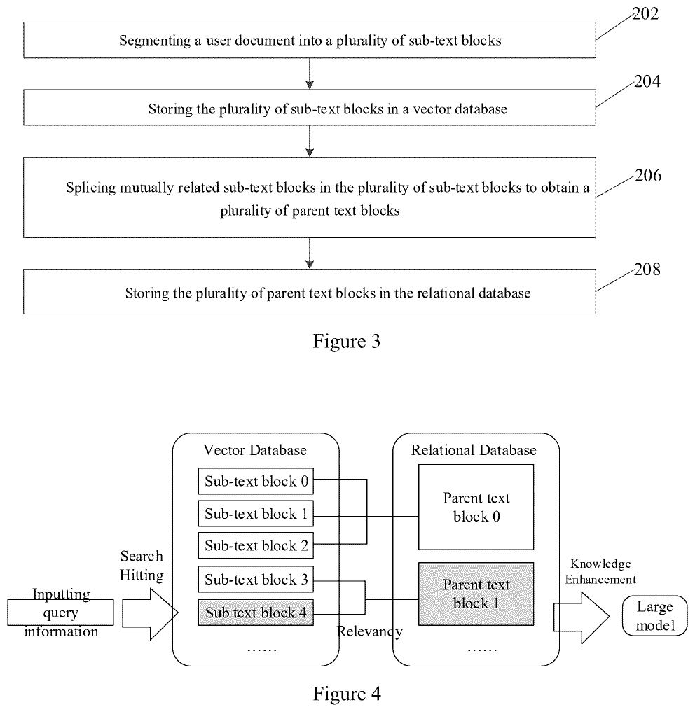

The present disclosure also provides a database establishment method. FIG. 3 illustrates a flow chart of a database establishment method consistent with the disclosed embodiments of the present disclosure. Referring to FIG. 3, the database establishment method includes S202, S204, S206, and S208.
S202: segmenting a user document into a plurality of sub-text blocks;
S204: storing the plurality of sub-text blocks in a vector database. A long user document may be segmented using a conventional document structure segmentation method into small sub-text blocks first, and the sub-text blocks may then be stored in the vector database. Since the sub-text blocks are generally small, the unessential information contained in the text may be little. Accordingly, matching may be easy during retrieval, retrieval accuracy may be improved, and resource consumption may be reduced.
S206: splicing mutually related sub-text blocks in the plurality of sub-text blocks to obtain a plurality of parent text blocks.
S208: storing the plurality of parent text blocks in the relational database. The ability of the large model to summarize problems may be used to splice the plurality of sub-text blocks into a parent text block and store the parent text block in the relational database. The parent text block in the relational database may be associated with the sub-text blocks in the vector database.

FIG. 4 illustrates a schematic structural diagram of a database establishment method consistent with the disclosed embodiments of the present disclosure. As shown in FIG. 4, when a user inputs query information, the vector database may be first searched for a sub-text block (for example, sub-text block 4) that matches the query information. Then, according to the sub-text block 4, a target parent text block (for example, parent text block 1) with more information may be derived from the relational database. The parent text block 1 is composed of the sub-text blocks 3 and 4 which are mutually related. The parent text block 1 and the first query information may then be input into a large model, and the large model may generate a final answer based on the parent text block 1 and the first query information.

In one embodiment, the user document is first segmented into smaller sub-text blocks and stored in a vector database. The mutually related sub-text blocks are spliced to obtain a parent text block, and the parent text block is stored in a relational database. After receiving first query information from a user, the first sub-text block that matches the first query information may be determined first, and then the target parent text block corresponding to the first sub-text block may be determined. Based on the target parent text block, a target model may be used to determine the first response information corresponding to the first query information. By using two types of text blocks, sub-text block and parent text block, for vector database retrieval and large model answer generation respectively, needs for retrieval performance and large-model generation performance may be met simultaneously. Accordingly, the semantic information contained in each text block may be more complete, the answer generation of the large model may be more accurate, and the retrieval efficiency may be higher. In addition, problems, such as, loss of useful information due to small sizes of the segmented text blocks, which leads to errors and deviations in answers of the large model, or more time and resource consumption by document retrieval and increased difficulty of target hitting due to large sizes of the segmented text blocks, may be avoided.

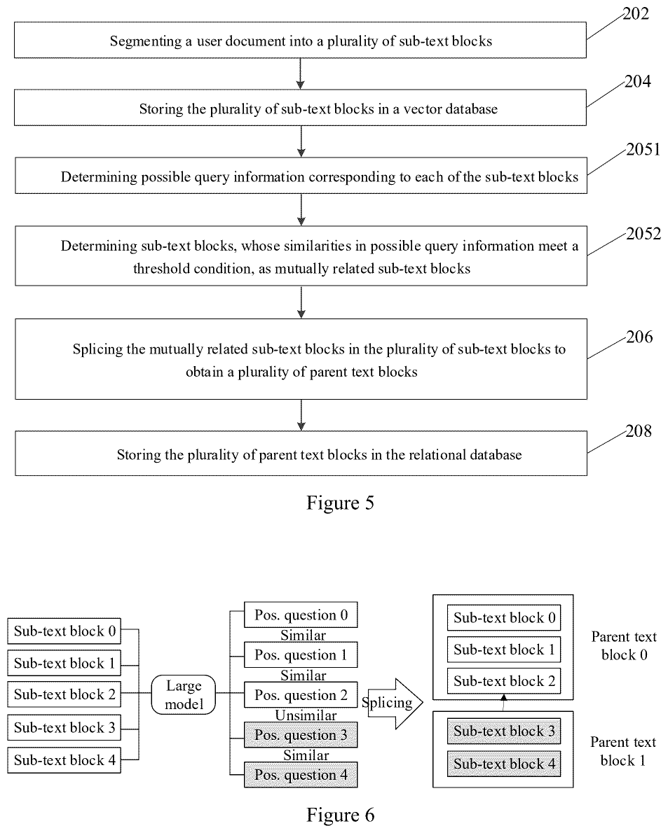

FIG. 5 illustrates a flow chart of another database establishment method consistent with the disclosed embodiments of the present disclosure. In some embodiments, as shown in FIG. 5, the database establishment method also includes S2051 and S2052.
S2501: determining suitable query information corresponding to each of the sub-text blocks.
S2502: determining sub-text blocks, whose similarities in suitable query information meet a threshold condition, as mutually related sub-text blocks. The threshold condition may be that the similarity of the suitable query information is greater than a similarity threshold. The suitable query information satisfying the threshold condition is similar suitable query information, and the suitable query information is also called a possible question. The suitable query information corresponding to each sub-text block may be determined. By comparing a plurality of suitable query information, sub-text blocks whose similarity between the suitable query information is greater than a similarity threshold may be determined as mutually related sub-text blocks. One sub-text block may correspond to one or more possible question, and a plurality of sub-text blocks may correspond to one possible question.

FIG. 6 illustrates a schematic diagram of splicing text blocks into a parent text block, consistent with the disclosed embodiments of the present disclosure. As shown in FIG. 6, in one embodiment, possible problems corresponding to sub-text blocks 0 to 4 may be determined respectively. The suitable query information corresponding to the sub-text block 0 is the possible question 0. The suitable query information corresponding to the sub-text block 1 is the possible question 1. The suitable query information corresponding to the sub-text block 2 is the possible question 2. The suitable query information corresponding to the sub-text block 3 is the possible question 3. The suitable query information corresponding to the sub-text block 4 is the possible question 4. The possible question 0 is similar to the possible question 1, and the possible question 1 is similar to the possible question 2. As such, the corresponding sub-text blocks 0, 1, and 2 are mutually related sub-text blocks, and the sub-text blocks 0, 1 and 2 may be spliced into the parent text block 0. The possible question 3 and the possible question 4 are similar, and the possible question 2 and the possible question 3 are not similar. As such, the corresponding sub-text blocks 3 and 4 are interrelated sub-text blocks. The sub-text block 3 and the sub-text block 4 may be spliced into the parent text block 1.

In one embodiment, by determining the suitable query information corresponding to the sub-text blocks, and then determining the mutually related sub-text blocks according to the similarity between the suitable query information, the mutually related sub-text blocks may be determined accurately.

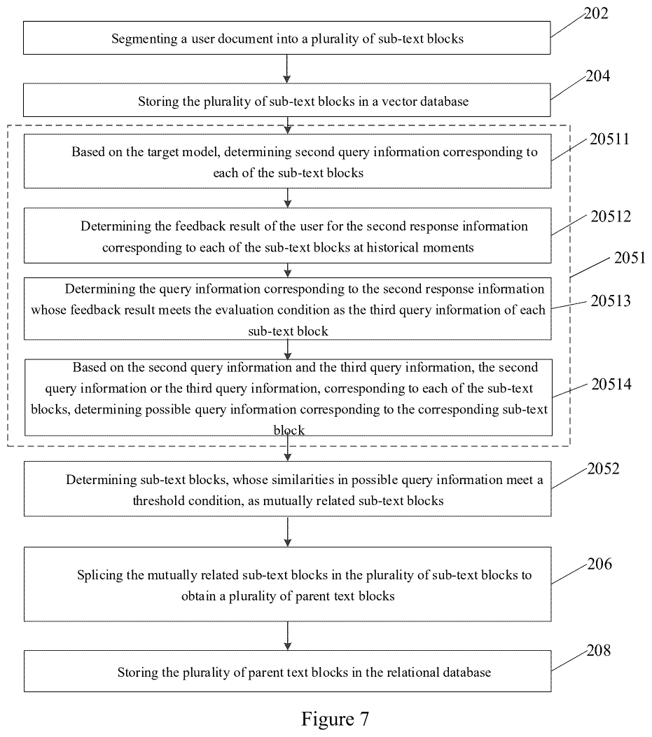

FIG. 7 illustrates a flow chart of another database establishment method consistent with the disclosed embodiments of the present disclosure. In some embodiments, as shown in FIG. 7, an operation of S2501 “determining suitable query information corresponding to each of the sub-text blocks” includes S20511, S20512, S20513, and S20514.
S20511: based on the target model, determining second query information corresponding to each of the sub-text blocks. The target model may be used to summarize the problems that the sub-text block may be used to solve (i.e., determine the second query information corresponding to the sub-text block), that is, to infer the question from the answer. The template for the prompt message used may be: Here is a sub-text block; Please summarize the problems that this sub-text block may address based on the information contained in the main text block.
S20512: determining the feedback result of the user for the second response information corresponding to each of the sub-text blocks at historical moments.
S20513: determining the query information corresponding to the second response information whose feedback result meets the evaluation condition as the third query information of each sub-text block. The third query information corresponding to the sub-text block may also be determined based on the historical questioning experience of the user. If the user has given satisfactory feedback on the answer to the sub-text block in previous inquiries, the question may also be recorded as a possible question for the corresponding sub-text block.
S20514: based on the second query information and the third query information, the second query information or the third query information, corresponding to each of the sub-text blocks, determining suitable query information corresponding to the corresponding sub-text block.

In one embodiment, the second query information corresponding to the sub-text block determined by the large model and the third query information corresponding to the sub-text block determined by the user's historical question experience may be referred to determine the third query information corresponding to the sub-text block. As such, the suitable query information corresponding to the sub-text block may be determined accurately.

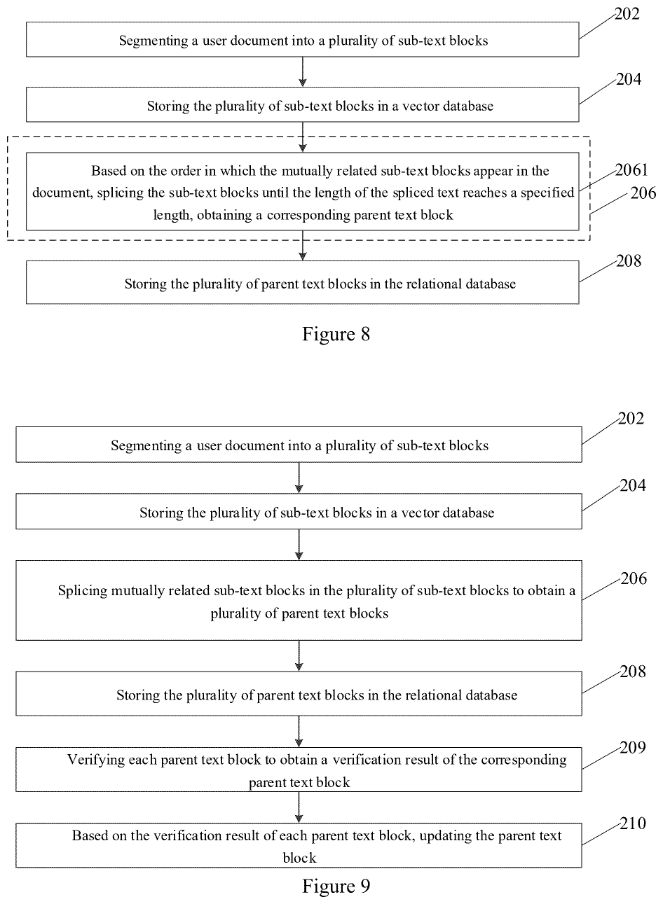

FIG. 8 illustrates a flow chart of another database establishment method consistent with the disclosed embodiments of the present disclosure. In some embodiments, as shown in FIG. 8, an operation of S206 “splicing mutually related sub-text blocks in the plurality of sub-text blocks to obtain a plurality of parent text blocks” includes S2061: based on the order in which the mutually related sub-text blocks appear in the document, splicing the sub-text blocks until the length of the spliced text reaches a specified length, obtaining a corresponding parent text block.

Based on the maximum length limit of the parent text block (i.e., specified length), the sub-text blocks may be spliced according to the order in which the sub-text blocks appear in the document to obtain the corresponding parent text block. In some embodiments, after the length of the spliced text reaches the specified length, a next parent text block may be spliced in sequence. That is, a plurality of mutually related sub-text blocks may be spliced together to obtain a plurality of parent text blocks. In this case, the semantics of the plurality of parent text blocks may be analyzed to obtain a final parent text block.

In one embodiment, the sub-text blocks may be spliced according to the order in which the sub-text blocks appear in the document to obtain the parent text block. As such, the sub-text blocks may be spliced accurately to obtain the parent text block.

FIG. 9 illustrates a flow chart of another database establishment method consistent with the disclosed embodiments of the present disclosure. In some embodiments, as shown in FIG. 9, the database establishment method also includes: S209 and S210.
S209: verifying each parent text block to obtain a verification result of the corresponding parent text block.
S210: based on the verification result of each parent text block, updating the parent text block.

After a parent text block is stored in the relational database, the parent text block may be verified. Based on the verification result of the parent text block, the parent text block in the relational database may be updated. The parent text block may also be verified before the parent text block is stored in the relational database. Based on the verification result of the parent text block, the parent text block may be updated, and the updated parent text block may be stored in the relational database. FIG. 9 merely illustrates that after the parent text block is stored in the relational database, the parent text block is verified, and based on the verification result of the parent text block, the parent text block in the relational database is updated.

In one embodiment, the parent text block is updated based on the verification result of the parent text block, and interference from invalid information in the parent text block may thus be avoided.

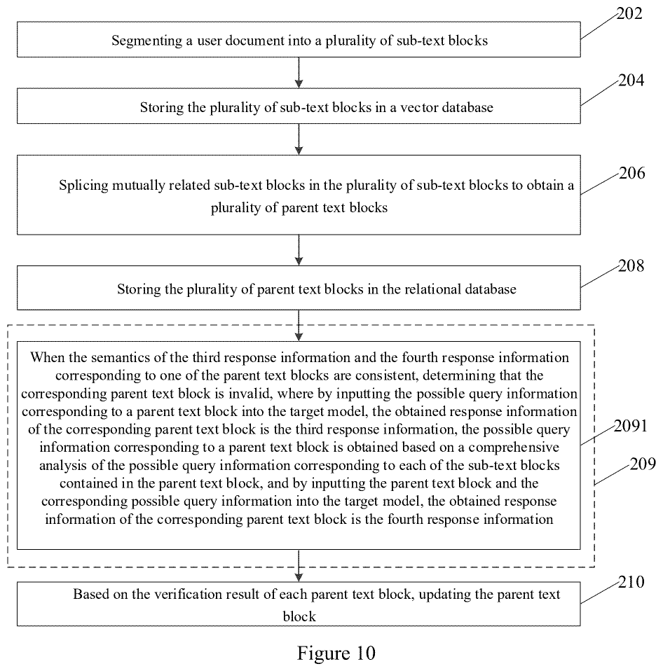

FIG. 10 illustrates a flow chart of another database establishment method consistent with the disclosed embodiments of the present disclosure. In some embodiments, as shown in FIG. 10, an operation of S209 “verifying each parent text block to obtain a verification result of the corresponding parent text block” includes S2091: when the semantics of the third response information and the fourth response information corresponding to one of the parent text blocks are consistent, determining that the corresponding parent text block is invalid.

By inputting the suitable query information corresponding to a parent text block into the target model, the obtained response information of the corresponding parent text block is the third response information. The suitable query information corresponding to a parent text block may be obtained based on a comprehensive analysis of the suitable query information corresponding to each of the sub-text blocks contained in the parent text block. By inputting the parent text block and the corresponding suitable query information into the target model, the obtained response information of the corresponding parent text block is the fourth response information.

An answer (i.e., the third response information) may be generated by inputting the possible question produced during the splicing process of a parent text block to the large model. Another answer (i.e., the fourth response information) may be generated by inputting the possible question produced during the splicing process of the parent text block, and the parent text block, into the large model. When the answer obtained by only inputting the possible question, and the answer obtained by inputting the parent text block and the possible question of the parent text block, have same semantics, the parent text block does not contain valid information.

In one embodiment, when the semantics of the answers obtained by adding a parent text block or not adding the parent text block to the input information of the large model, respectively, are consistent, it may be determined that the parent text block does not contain valid information.

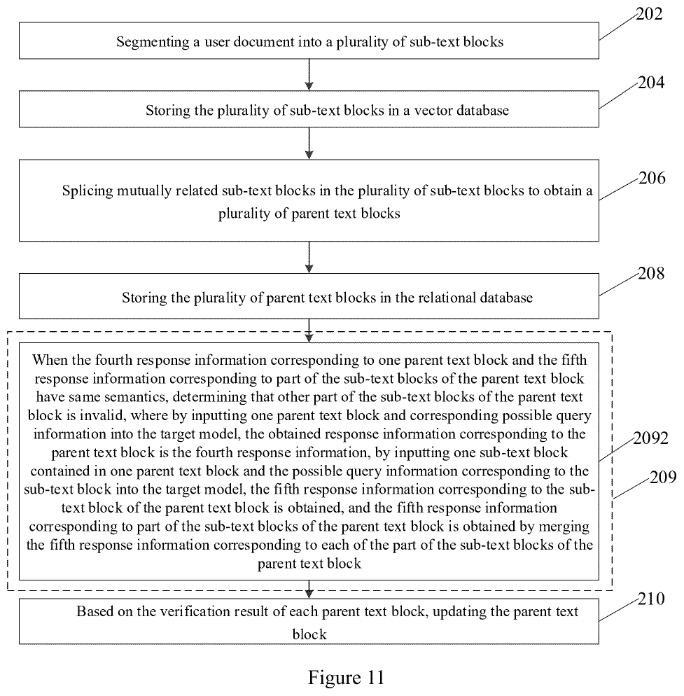

FIG. 11 illustrates a flow chart of another database establishment method consistent with the disclosed embodiments of the present disclosure. In some embodiments, as shown in FIG. 11, an operation of S209 “verifying each parent text block to obtain a verification result of the corresponding parent text block” includes S2092: when the fourth response information corresponding to one parent text block and the fifth response information corresponding to part of the sub-text blocks of the parent text block have same semantics, determining that other part of the sub-text blocks of the parent text block is invalid.

By inputting one parent text block and corresponding suitable query information into the target model, the obtained response information corresponding to the parent text block is the fourth response information. By inputting one sub-text block contained in one parent text block and the suitable query information corresponding to the sub-text block into the target model, the fifth response information corresponding to the sub-text block of the parent text block may be obtained. The fifth response information corresponding to part of the sub-text blocks of the parent text block may be obtained by merging the fifth response information corresponding to each of the part of the sub-text blocks of the parent text block.

By inputting the possible questions generated during the splicing process of the parent text block into the large model, and also inputting the corresponding parent text block and the sub-text blocks corresponding to the parent text block into the large model, a corresponding number of answers may be generated. Each sub-text block corresponds to one fifth response information. When the answer obtained by inputting the parent text block and the answer obtained by merging the answers (fifth response information) corresponding to part of the sub-text blocks are semantically consistent, it may be determined that only the corresponding part of the sub-text blocks are valid, and other sub-text blocks are invalid information.

In one embodiment, when the semantics of the answers obtained by adding one parent text block and adding part of the sub-text blocks of the parent text block in the input information of the large model, respectively, are consistent, the verification result of the parent text block may be that other part of the sub-text blocks of the parent text block are invalid.

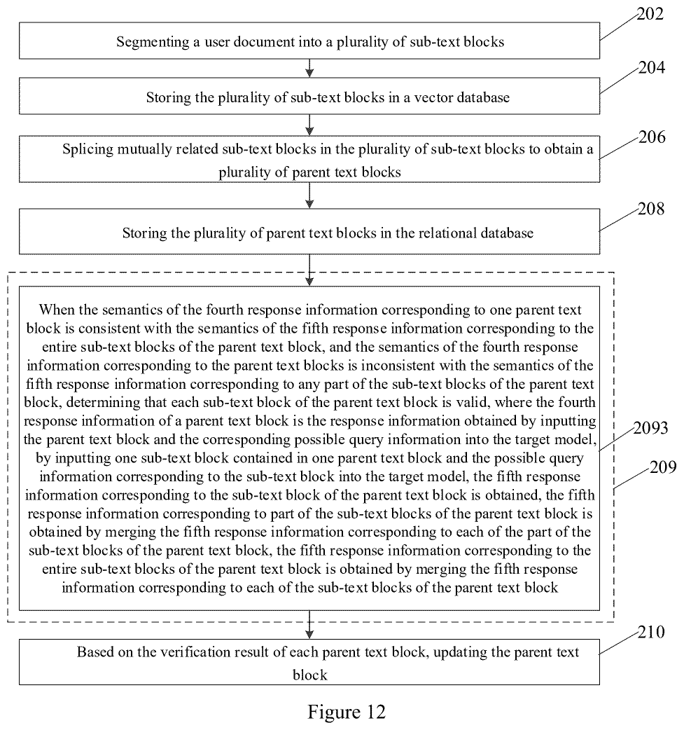

FIG. 12 illustrates a flow chart of another database establishment method consistent with the disclosed embodiments of the present disclosure. In some embodiments, as shown in FIG. 12, an operation of S209 “verifying each parent text block to obtain a verification result of the corresponding parent text block” includes S2093.
S2093: when the semantics of the fourth response information corresponding to one parent text block is consistent with the semantics of the fifth response information corresponding to the entire sub-text blocks of the parent text block, and the semantics of the fourth response information corresponding to the parent text blocks is inconsistent with the semantics of the fifth response information corresponding to any part of the sub-text blocks of the parent text block, determining that each sub-text block of the parent text block is valid.

The fourth response information of a parent text block is the response information obtained by inputting the parent text block and the corresponding suitable query information into the target model. By inputting one sub-text block contained in one parent text block and the suitable query information corresponding to the sub-text block into the target model, the fifth response information corresponding to the sub-text block of the parent text block may be obtained. The fifth response information corresponding to part of the sub-text blocks of the parent text block may be obtained by merging the fifth response information corresponding to each of the part of the sub-text blocks of the parent text block. The fifth response information corresponding to the entire sub-text blocks of the parent text block may be obtained by merging the fifth response information corresponding to each of the sub-text blocks of the parent text block.

When the answer obtained by inputting the parent text block is semantically consistent with the answer obtained by merging the fifth response information of each sub-text block, but the answer obtained by merging the fifth response information of any part of the sub-text blocks is not semantically consistent with the answer obtained by inputting the parent text block, it may be considered that each sub-text block is valid. As such, the parent text block is properly spliced, or may be further spliced.

In one embodiment, when the semantics of the answer obtained by inputting the parent text block to the large model and the answer obtained by merging the fifth response information of any part of the sub-text blocks of the parent text block are inconsistent, and the semantics of the answer obtained by inputting the parent text block to the large model and the answer obtained by merging the fifth response information of each of the sub-text blocks of the parent text block are consistent, the verification result of the parent text block may be that each sub-text block is valid.

It should be noted that in present disclosure, when the response information generation method is implemented in a form of a software function module, and sold or used as an independent product, the method may also be stored in a computer-readable storage medium. Based on this understanding, the technical solution of the present disclosure, or in other words, the part that contributes to existing technology, may essentially be embodied in a form of a software product. The software product may be stored in a storage medium. The software product may include a plurality of instructions for enabling an electronic device to execute each or part of the method provided in the present disclosure. The electronic device may be a mobile phone, a tablet computer, a desktop computer, a personal digital assistant, a navigator, a digital phone, a video phone, a television, a sensor device, etc. The storage media may include a U disk, a mobile hard disk, a read only memory (ROM), a magnetic disk or CD, and other media that may store program codes. The present disclosure is not limited to any specific combination of hardware and software.

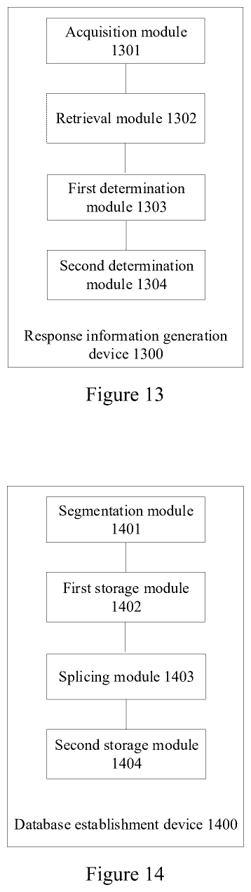

The present disclosure also provides a response information generation device. FIG. 13 illustrates a schematic composition structural diagram of a response information generation device consistent with the disclosed embodiments of the present disclosure. As shown in FIG. 13, the response information generation device 1300 includes: an acquisition module 1301, a retrieval module 1302, a first determination module 1303, and a second determination module 1304.

The acquisition module 1301 is configured to acquire first query information of a user. The retrieval module 1302 is configured to retrieve a first sub-text block matching the first query information. The first determination module 1303 is configured to determine a target parent text block corresponding to the first sub-text block. The target parent text block includes the first sub-text block and a second sub-text block associated with the first sub-text block. The second determination module 1304 is configured to determine the first response information corresponding to the first query information based on the target parent text block using a target model.

In some embodiments, the retrieval module 1302 includes a retrieval submodule, configured for retrieving a first sub-text block matching the first query information in a vector database. The first determination module 1303 includes a first determination submodule, configured to determine a target parent text block corresponding to the first sub-text block from a relational database. The second determination module 1304 includes a second determination submodule, configured to determine the target parent text block as prompt information of the target model, to guide the target model to determine the first response information corresponding to the first query information.

FIG. 14 illustrates a schematic composition structural diagram of a database establishment device consistent with the disclosed embodiments of the present disclosure. As shown in FIG. 14, the database establishment device 1400 includes: a segmentation module 1401, a first storage module 1402, a splicing module 1403 and a second storage module 1404.

The segmentation module 1401 is configured to segment a user document into a plurality of sub-text blocks. The first storage module 1402 is configured to store the plurality of sub-text blocks into a vector database. The splicing module 1403 is configured to splice the sub-text blocks that are mutually related in the plurality of sub-text blocks to obtain a plurality of parent text blocks. The second storage module 1404 is configured to store the plurality of parent text blocks in a relational database.

In some embodiments, the database establishment device also includes a third determination module and a fourth determination module. The third determination module is configured to determine the suitable query information corresponding to each of the sub-text blocks. The fourth determination module is configured to determine the sub-text blocks whose similarities in the suitable query information meet a threshold condition as mutually related sub-text blocks.

In some embodiments, the third determination module includes a third determination submodule, a fourth determination submodule, a fifth determination submodule, and a sixth determination submodule. The third determination submodule is configured to determine second query information corresponding to each of the sub-text blocks based on the target model. The fourth determination submodule is configured to determine the feedback result of the user at historical moments for the second response information corresponding to each of the sub-text blocks. The fifth determining submodule is configured to determine the query information corresponding to the second response information whose feedback result meets the evaluation condition, as the third query information of each sub-text block. The sixth determination submodule is configured to, based on the second query information and the third query information, the second query information, or the third query information corresponding to each of the sub-text blocks, determine the suitable query information of the corresponding sub-text block.

In some embodiments, the splicing module 1403 includes a splicing submodule. The splicing submodule is configured to splice the sub-text blocks based on the order in which the mutually related sub-text blocks appear in the document until the length of the spliced text reaches a specified length, thereby obtaining a corresponding parent text block. The database establishment device also includes a verification module and an updating module. The verification module is configured to verify each of the parent text blocks and obtain a verification result of the corresponding parent text block. The updating module is configured to update the parent text block based on the verification result of each parent text block.

In some embodiments, the verification module includes a first verification submodule. The first verification submodule is configured to, when the semantics of the third response information and the fourth response information corresponding to one parent text block are consistent, determine that the parent text block is invalid. By inputting the suitable query information corresponding to a parent text block into the target model, the obtained response information of the corresponding parent text block is the third response information. The suitable query information corresponding to a parent text block may be obtained based on a comprehensive analysis of the suitable query information corresponding to each of the sub-text blocks contained in the parent text block. By inputting the parent text block and the corresponding suitable query information into the target model, the obtained response information of the corresponding parent text block is the fourth response information.

In some embodiments, the verification module includes a second verification submodule. The second verification submodule is configured to, when the fourth response information corresponding to one parent text block and the fifth response information corresponding to part of the sub-text blocks of the parent text block have same semantics, determine that other part of the sub-text blocks of the parent text block is invalid. By inputting one parent text block and corresponding suitable query information into the target model, the obtained response information corresponding to the parent text block is the fourth response information. By inputting one sub-text block contained in one parent text block and the suitable query information corresponding to the sub-text block into the target model, the fifth response information corresponding to the sub-text block of the parent text block may be obtained. The fifth response information corresponding to part of the sub-text blocks of the parent text block may be obtained by merging the fifth response information corresponding to each of the part of the sub-text blocks of the parent text block.

In some embodiments, the verification module includes a third verification submodule. The third verification submodule is configured to, when the semantics of the fourth response information corresponding to one parent text block is consistent with the semantics of the fifth response information corresponding to the entire sub-text blocks of the parent text block, and the semantics of the fourth response information corresponding to the parent text blocks is inconsistent with the semantics of the fifth response information corresponding to any part of the sub-text blocks of the parent text block, determine that each sub-text block of the parent text block is valid. The fourth response information of a parent text block is the response information obtained by inputting the parent text block and the corresponding suitable query information into the target model. By inputting one sub-text block contained in one parent text block and the suitable query information corresponding to the sub-text block into the target model, the fifth response information corresponding to the sub-text block of the parent text block may be obtained. The fifth response information corresponding to part of the sub-text blocks of the parent text block may be obtained by merging the fifth response information corresponding to each of the part of the sub-text blocks of the parent text block. The fifth response information corresponding to the entire sub-text blocks of the parent text block may be obtained by merging the fifth response information corresponding to each of the sub-text blocks of the parent text block.

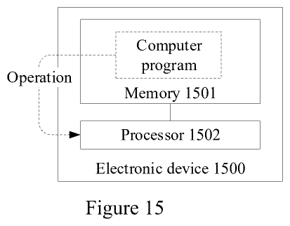

The present disclosure also provides an electronic device. FIG. 15 illustrates a schematic structural diagram of an electronic device consistent with the disclosed embodiments of the present disclosure. As shown in FIG. 15, the hardware entity of the electronic device 1500 includes a memory 1501 and a processor 1502. The memory 1501 stores a computer program that may be executed by the processor 1502. When the processor 1502 executes the program, operations in the response information generation method or the database establishment method provided by the present disclosure may be implemented.

The memory 1501 is configured to store instructions and applications executable by the processor 1502, and may also cache data to be processed or processed by the processor 1502 and various modules in the device 1500 (for example, image data, audio data, voice communication data, and video communication data). The memory 1501 may be implemented through a flash memory (FLASH) or a random access memory (RAM).

The present disclosure also provides a computer-readable storage medium. The computer readable storage medium is stored with a computer program. When the computer program is executed by a processor of an electronic device, the computer program may implement the response information generation method or database establishment method provided by the present disclosure.

It should be noted that the above-mentioned computer-readable storage medium may be a read-only memory (ROM), a programmable read-only memory (PROM), an erasable programmable read-only memory (EPROM), an electrically erasable programmable read-only memory (EEPROM), a ferromagnetic random access memory (FRAM), a flash memory, a magnetic surface memory, an optical disk, or a compact disc read-only memory (CD-ROM) or the like. The above-mentioned electronic device may also be various electronic devices including one or any combination of the above memories, such as a mobile phone, a computer, a tablet device, a personal digital assistant, etc.

Those skilled in the art may understand that the embodiments of the present disclosure may be implemented by means of software plus necessary general hardware nodes, and may also be implemented by hardware, but in many cases the means of software plus necessary general hardware nodes may be a better implementation method. Based on this understanding, the technical solution of the present disclosure, or the part that contributes to existing technology, may be embodied in the form of a software product. The software product may be stored in a storage medium (such as a ROM/RAM, a magnetic disk, or an optical disk), and may include a number of instructions for enabling a terminal device (such as a mobile phone, a computer, a server, an air conditioner, or a network device, etc.) to execute the methods provided by the present disclosure.

The present disclosure is described with reference to flowcharts and/or block diagrams of methods, devices (systems), and computer program products according to embodiments of the present disclosure. It should be understood that each process and/or block in the flowchart and/or block diagram, and a combination of the processes and/or blocks in the flowchart and/or block diagram may be implemented by computer program instructions. These computer program instructions may be provided to a processor of a general-purpose computer, a special-purpose computer, an embedded processor or other programmable data processing device to form a machine. As such, through the instructions executed by the processor of a computer or other programmable data processing device, a device for implementing the functions specified in one or more processes in the flowchart and/or one or more blocks in the block diagram may be realized.

These computer program instructions may also be stored in a computer-readable memory that may direct a computer or other programmable data processing device to operate in a specific manner, such that the instructions stored in the computer readable memory may produce an article of manufacture including an instruction device. The instruction device may realize functions specified in one or more processes of the flowchart and/or one or more blocks of the block diagram.

These computer program instructions may also be loaded onto a computer or other programmable data processing device, such that a series of operations may be executed on the computer or other programmable device to realize a computer-implemented process. As such, the instructions executed on the computer or other programmable device may provide processes for implementing the functions specified in one or more flows of the flowchart and/or one or more blocks of the block diagram.

As disclosed, the technical solutions of the present disclosure have the following advantages.

In the response information generation method, the database establishment method and the device provided by the present disclosure, the first sub-text block that matches the first query information may be determined first, and the target parent text block corresponding to the first sub-text block may then be determined. Based on the target parent text block, a target model may be used to determine the first response information corresponding to the first query information. By using two types of text blocks, sub-text block and parent text block, for vector database retrieval and large model answer generation respectively, needs for retrieval performance and large-model generation performance may be met simultaneously. Accordingly, the semantic information contained in each text block may be more complete, the answer generation of the large model may be more accurate, and the retrieval efficiency may be higher. In addition, problems, such as, loss of useful information due to small sizes of the segmented text blocks, which leads to errors and deviations in answers of the large model, or more time and resource consumption by document retrieval and increased difficulty of target hitting due to large sizes of the segmented text blocks, may be avoided.

The embodiments disclosed in the present disclosure are exemplary only and not limiting the scope of the present disclosure. Various combinations, alternations, modifications, or equivalents to the technical solutions of the disclosed embodiments may be obvious to those skilled in the art and may be included in the present disclosure. Without departing from the spirit of the present disclosure, the technical solutions of the present disclosure may be implemented by other embodiments, and such other embodiments are intended to be encompassed within the scope of the present disclosure.

What is claimed is:

1. A response information generation method, comprising:
obtaining first query information of a user;
retrieving a first sub-text block matching the first query information;
determining a target parent text block corresponding to the first sub-text block, wherein the target parent text block includes the first sub-text block and a second sub-text block associated with the first sub-text block; and
determining first response information corresponding to the first query information based on the target parent text block using a target model.

2. The method according to claim 1, wherein:
retrieving the first sub-text block matching the first query information includes retrieving the first sub-text block matching the first query information in a vector database.

3. The method according to claim 1, wherein:
determining the target parent text block corresponding to the first sub-text block includes determining the target parent text block corresponding to the first sub-text block from a relational database.

4. The method according to claim 1, wherein:
determining the first response information corresponding to the first query information based on the target parent text block using the target model includes determining the target parent text block as prompt information of the target model to guide the target model to determine the first response information corresponding to the first query information.

5. A database establishment method, comprising:
segmenting a user document of into a plurality of sub-text blocks;
storing the plurality of sub-text blocks in a vector database;
splicing mutually related sub-text blocks of the plurality of sub-text blocks to obtain a plurality of parent text blocks; and
storing the plurality of parent text blocks in a relational database.

6. The method according to claim 5, further comprising:
determining suitable query information corresponding to each of the plurality of sub-text blocks; and
determining sub-text blocks of the plurality of sub-text blocks, whose similarities in the suitable query information meet a threshold condition, as the mutually related sub-text blocks.

7. The method according to claim 6, wherein determining the suitable query information corresponding to each of the plurality of sub-text blocks includes:
based on a target model, determining second query information corresponding to each of the plurality of sub-text blocks;
determining a feedback result of a user for second response information corresponding to each of the plurality of sub-text blocks at historical moments;
determining query information corresponding to the second response information for which the feedback result meets an evaluation condition as third query information of each of the plurality of sub-text blocks; and
based on the second query information and the third query information, the second query information, or the third query information, corresponding to each of the plurality of sub-text blocks, determining the suitable query information corresponding to each of the plurality of sub-text blocks.

8. The method according to claim 7, wherein splicing the mutually related sub-text blocks in the plurality of sub-text blocks to obtain the plurality of parent text blocks includes:
based on an order in which the mutually related sub-text blocks appear in the user document, splicing the mutually related sub-text blocks until a length of a spliced text reaches a specified length, obtaining a parent text block of the plurality of parent text blocks, corresponding to the mutually related sub-text blocks.

9. The method according to claim 8, further comprising:
verifying each parent text block of the plurality of parent text blocks, and obtaining a verification result corresponding to each parent text block of the plurality of parent text blocks; and
based on the verification result of each parent text block of the plurality of parent text blocks, updating the plurality of parent text blocks.

10. The method according to claim 9, wherein verifying each parent text block of the plurality of parent text blocks, and obtaining the verification result corresponding to each parent text block of the plurality of parent text blocks include:
when third response information and fourth response information corresponding to a parent text block of the plurality of parent text blocks are semantically consistent, determining that the parent text block is invalid,
wherein:
by inputting suitable query information corresponding to the parent text block into the target model, the third response information corresponding to the parent text block is obtained, wherein the suitable query information corresponding to the parent text block is obtained based on a comprehensive analysis of the suitable query information corresponding to each of the mutually related sub-text blocks of the parent text block; and
by inputting the parent text block and the suitable query information corresponding to the parent text block into the target model, the fourth response information corresponding to the parent text block is obtained.

11. The method according to claim 9, wherein verifying each parent text block of the plurality of parent text blocks, and obtaining the verification result corresponding to each parent text block of the plurality of parent text blocks include:
when fourth response information corresponding to a parent text block of the plurality of parent text blocks and fifth response information corresponding to a part of the mutually related sub-text blocks of the parent text block are semantically consistent, determining that other part of the mutually related sub-text blocks of the parent text block is invalid,
wherein:
by inputting the parent text block and suitable query information corresponding to the parent text block into the target model, the fourth response information corresponding to the parent text block is obtained, wherein the suitable query information corresponding to the parent text block is obtained based on a comprehensive analysis of the suitable query information corresponding to each of the mutually related sub-text blocks of the parent text block;
by inputting a sub-text block of the mutually related sub-text blocks of the parent text block and suitable query information corresponding to the sub-text block into the target model, fifth response information corresponding to the sub-text block of the mutually related sub-text blocks of the parent text block is obtained; and
the fifth response information corresponding to a part of the mutually related sub-text blocks of the parent text block is obtained by merging the fifth response information corresponding to each of the part of the mutually related sub-text blocks of the parent text block.

12. The method according to claim 9, wherein verifying each parent text block of the plurality of parent text blocks, and obtaining the verification result corresponding to each parent text block of the plurality of parent text blocks include:
when fourth response information corresponding to a parent text block and fifth response information corresponding to entire of the mutually related sub-text blocks of the parent text block are semantically consistent, and the fourth response information corresponding to the parent text blocks and fifth response information corresponding to any part of the mutually related sub-text blocks of the parent text block are semantically inconsistent, determining that each of the mutually related sub-text blocks of the parent text block is valid, wherein:
by inputting the parent text block and suitable query information corresponding to the parent text block into the target model, the fourth response information corresponding to the parent text block is obtained, wherein the suitable query information corresponding to the parent text block is obtained based on a comprehensive analysis of the suitable query information corresponding to each of the mutually related sub-text blocks of the parent text block;
by inputting a sub-text block of the mutually related sub-text blocks of the parent text block and suitable query information corresponding to the sub-text block into the target model, fifth response information corresponding to the sub-text block of the mutually related sub-text blocks of the parent text block is obtained;
the fifth response information corresponding to a part of the mutually related sub-text blocks of the parent text block is obtained by merging the fifth response information corresponding to each of the part of the mutually related sub-text blocks of the parent text block; and
the fifth response information corresponding to entire of the mutually related sub-text blocks of the parent text block is obtained by merging the fifth response information corresponding to each of the mutually related sub-text blocks of the parent text block.

13. An electronic device, comprising:
one or more processors, and a memory containing a computer program that, when being executed, causes the one or more processors to perform:
obtaining first query information of a user;
retrieving a first sub-text block matching the first query information;
determining a target parent text block corresponding to the first sub-text block, wherein the target parent text block includes the first sub-text block and a second sub-text block associated with the first sub-text block; and
determining first response information corresponding to the first query information based on the target parent text block using a target model.

14. The device according to claim 13, wherein the one or more processors are further configured to perform:
retrieving the first sub-text block matching the first query information in a vector database.

15. The device according to claim 13, wherein the one or more processors are further configured to perform:
determining the target parent text block corresponding to the first sub-text block from a relational database.

16. The device according to claim 13, wherein the one or more processors are further configured to perform:
determining the target parent text block as prompt information of the target model to guide the target model to determine the first response information corresponding to the first query information.

17. An electronic device comprising one or more processors and a memory containing a computer program that, when being executed, causes the one or more processors to perform the database establishment method according to claim 5.

18. The device according to claim 17, wherein the one or more processors are further configured to perform:
determining suitable query information corresponding to each of the plurality of sub-text blocks; and
determining sub-text blocks of the plurality of sub-text blocks, whose similarities in the suitable query information meet a threshold condition, as the mutually related sub-text blocks.

19. The device according to claim 18, wherein the one or more processors are further configured to perform:
based on a target model, determining second query information corresponding to each of the plurality of sub-text blocks;
determining a feedback result of a user for second response information corresponding to each of the plurality of sub-text blocks at historical moments;
determining query information corresponding to the second response information for which the feedback result meets an evaluation condition as third query information of each of the plurality of sub-text blocks; and
based on the second query information and the third query information, the second query information, or the third query information, corresponding to each of the plurality of sub-text blocks, determining the suitable query information corresponding to each of the plurality of sub-text blocks.

20. The device according to claim 19, wherein the one or more processors are further configured to perform:
based on an order in which the mutually related sub-text blocks appear in the user document, splicing the mutually related sub-text blocks until a length of a spliced text reaches a specified length, obtaining a parent text block of the plurality of parent text blocks, corresponding to the mutually related sub-text blocks.
